(19) United States
(12) Patent Application Publication
(10) Pub. No.: US 2007/0106915 A1
(43) Pub. Date: May 10, 2007

(54) Reset circuit for automatically resetting an MCU upon turning on a power and the method thereof

(75) Inventor: Shen-Yuan Shie, Taipei City (TW)

Correspondence Address: BACON & THOMAS, PLLC, 625 SLATERS LANE, FOURTH FLOOR, ALEXANDRIA, VA, 22314, US

(73) Assignee: Tatung Company, Taipei City (TW)

(21) Appl. No.: 11/345,526

(22) Filed: Feb. 2, 2006

(30) Foreign Application Priority Data
Nov. 4, 2005 (TW) 094138832

(51) Int. Cl. G06F 1/00

(52) U.S. Cl. 713/300

(57) ABSTRACT

A reset circuit and the method thereof for automatically resetting a microcontroller unit upon turning on the power that is applied to an electronic device is disclosed, which comprises an EEPROM, an MCU, a reset circuit and an AND gate. As the electronic device is plugged into the power outlet, the MCU reads the flag state recorded within the EEPROM and adjusts it to Low. Every time the power of the electronic device is turned on by pressing the power button, the MCU will automatically set a GPIO pin to output a trigger signal for triggering the reset pin of the MCU, allowing the MCU to initiate the reset operation by restarting and resetting the settings of both the hardware and software components within the MCU.

### BACKGROUND OF THE INVENTION

1. Field of the Invention

The present invention relates to a reset circuit and the method thereof and, more particularly, to a reset circuit for automatically resetting the settings of a microcontroller unit (MCU) upon turning on the power for an electronic device and the method thereof.

2. Description of Related Art

Conventional electronic devices, which are controlled by MCUs (for example, television sets, DVD players, etc.), are designed with a standby function, in which the MCU within the electronic device initiates the initial settings and enters its standby mode once the electronic device is plugged onto the power outlet. Both the hardware and the software components within the MCU of every electronic device are preset with proper commands and default values. At times when users operate the electronic devices, the MCU is more than often affected by external interferences, such as electromagnetic waves or surrounding magnetic fields that would potentially disrupt the internal settings and commands, ultimately contributing to performance errors in the electronic device. Instances of such errors can be like abnormal images on the television screen or response failures using a remote control. In order to solve such MCU errors or even total failures, the MCU must be reset such that both the hardware and software components of the MCU are then able to resume to their default values, for which the electronic device can once again be restored to normal. However, conventional electronic devices cannot offer the reset mechanism specifically intended for the MCU. Thus, to reset the MCU has to rely on users physically unplugging the power for the electronic device from the power outlet and plugging it back in again in order to restore the MCU's default values for further operations.

From the above, it is known that the conventional method for resetting an MCU must proceed with users physically unplugging the power in order to restore the default values set in the MCU, which in fact causes inconvenience for the users. Therefore, it is desirable to provide an easy, quick yet effective method to mitigate the aforementioned deficiencies.

### SUMMARY OF THE INVENTION

The object of the present invention is to provide a circuit and the method thereof for automatically resetting an MCU upon turning on a power, by which every time when the power button is pressed to turn on an electronic device, both the hardware and software components of the MCU will first be reset, allowing settings within the MCU to restore to default values, for which the stability of the electronic device can be improved as a result.

To achieve the object, the reset circuit of the present invention that is applied to an electronic device for automatically resetting the MCU upon turning on the power comprises a power button, an Electronic Erasable Programmable Read Only Memory (EEPROM), which utilizes a flag to record whether the power status of the electronic device is on or off, a microcontroller unit (MCU), which connects with said EEPROM, wherein the MCU comprises a reset pin and a GPIO pin, an AND gate having two input terminals, with one of the input terminals connecting with a resistor capacitor circuit and the other terminal connecting with the GPIO pin of the MCU, and a reset circuit, which connects to the reset pin of the MCU and the output terminal of the AND gate. Having the settings being reset as the electronic device is plugged onto the power outlet, the MCU reads the flag state recorded in the EEPROM; if the power is not on, the electronic device then enters a standby mode. As the power button is pressed, the GPIO pin of the MCU outputs a trigger signal through both the AND gate and the reset circuit to trigger the reset pin of the MCU for resetting default values of both the hardware and software therein.

Another feature of the present invention is to provide a method for automatically resetting an MCU upon turning on the power that is applied to an electronic device. Pressing the power button is employed to turn on an electronic device and to reset the MCU automatically for further power control operations as the electronic device is plugged into the power outlet under a standby mode. The method comprises the followings steps: (A) setting up a range of default values for the MCU and setting a GPIO pin as high level; (B) reading the power flag state of an EEPROM by the MCU; executing step (C) if the flag state is at high level, executing step (D) if said flag state is at low level; (C) adjusting the flag state to low level by the MCU and saving same in the EEPROM, turning the power on: to execute monitoring and detecting operations; (D) turning the power off by the MCU: to execute monitoring and detecting operations; (E) determining by the MCU whether the power button has been pressed; if not pressed, continuing to monitor; if the power button has been pressed, then executing step (F); (F) determining by the MCU whether the power is turned off at the time being; if so, executing step (G), otherwise executing step (D); (G) adjusting the power flag state to high level by the MCU and saving it in the EEPROM, and a GPIO is set as low level for resetting the MCU; and (H) initiating the reset command by the MCU for resetting both the hardware and software settings therein, for returning to step (A) to proceed with further monitoring operations.

### BRIEF DESCRIPTION OF THE DRAWINGS

FIG. 1 is a schematic diagram illustrating a reset circuit for automatically resetting the MCU upon turning on the power according to the preferred embodiment of the present invention.

FIG. 2 is a flow chart laying out the method for automatically resetting the MCU upon turning on the power according to the preferred embodiment of the present invention.

### DETAILED DESCRIPTION OF THE PREFERRED EMBODIMENT

Contemporary electronic products, such as television sets, DVD players and others, are all equipped with an MCU within the internal installment, and a reset pin and a plurality of GPIO pins are mounted on every MCU. The present invention is to initiate both the reset operations of the hardware and the software upon turning on an electronic device using the GPIO pins on the MCU to output a trigger signal for triggering the reset pin on the MCU; once the reset operation takes place, the electronic device then enters an operation mode for proceeding with various monitoring operations.

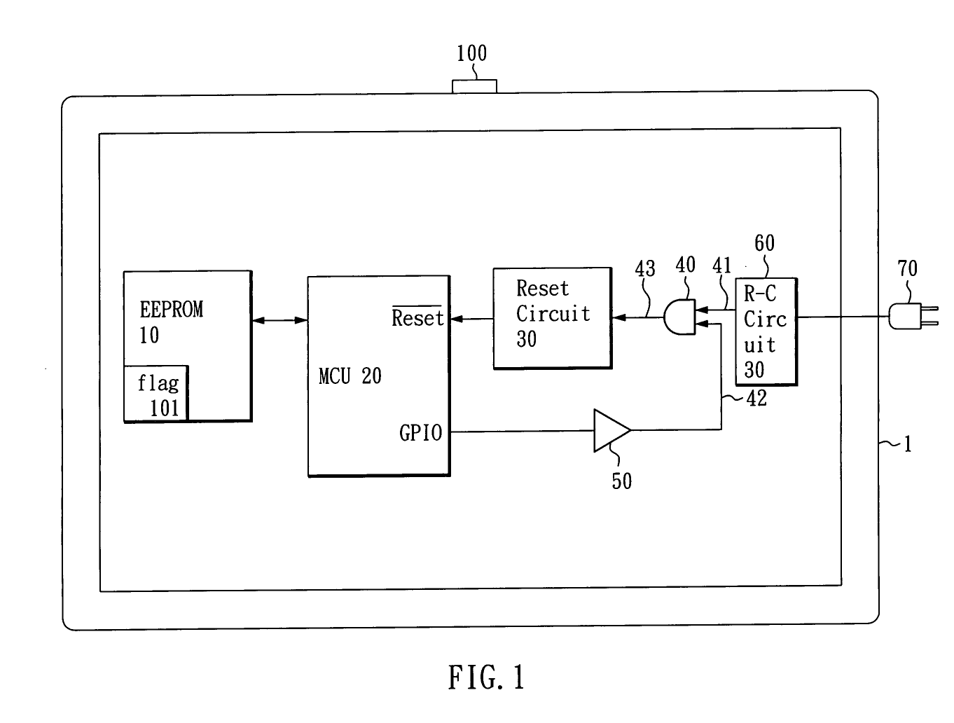

With reference to the reset circuit for automatically resetting the MCU upon turning on the power as shown in FIG. 1, the reset circuit of the present invention is installed in an electronic device 1, for example, a television set, a DVD player, etc.; the layout of the reset MCU comprises a power button 100, an EEPROM 10, an MCU 20, a reset circuit 30, an AND Gate 40 and a buffer 50. The power button 100 is the power switch or the press-button of the electronic device 1 that can be either installed on the device 1 and/or installed on a remote control. As the plug 70 of the electronic device 1 is plugged into the power outlet, the device 1 is turned on upon by pressing the power button 100. The EEPROM 10 is a storing unit, for which the power status of the device 1 is recorded using a flag 101. In this preferred embodiment, two modes, Low and High, are used to refer to the power status of the device 1; that is, the flag 101 state set at Low implies that the electronic device is either currently turned off or that the power button has not yet been pressed; the flag 101 state set at High implies that the electronic device is either currently turned on or that the power button has been pressed (which requires automatically resetting the MCU). The MCU 20, which connects with the EEPROM 10, comprises a reset pin and a GPIO pin. When the reset operation takes place, the GPIO pin on the MCU 20 is set as Low to trigger the reset pin, so that the MCU is able to initiate the reset operation for both the hardware and the software components therein. The AND gate 40 comprises two input terminals 41 and 42 and an output terminal 43, in which the input terminal 41 connects to an RC circuit 60, the input terminal 42 connects to the GPIO pin of the MCU 20 through the buffer 50, and the output terminal 43 connects with the reset circuit 43. In this preferred embodiment, the reset circuit 30 is a reset integrated circuit in general. Both the input and output of the buffer 50 connect to the GPIO pin of the MCU 20 and the input terminal 42 of the AND gate 40 respectively, and the RC circuit connects to the DC power of the electronic device 1.

As the plug 70 of the electronic device 1 is plugged into the power outlet while having the device reset its settings, the MCU 20 will read the flag 101 status saved in the EEPROM 10 and determine whether the flag 101 status is Low or High. If the flag 101 is Low, it implies either the power is turned off or that the power button has not yet been pressed, in which there is no need to reset or turn off the power to proceed with monitoring and detecting operations. However, when pressing the power button 100, the flag 101 saved in the EEPROM 10 will be set as High, and the MCU 20 will drive the GPIO pin to output a trigger signal. Via the buffer 50, the AND gate 40 and the reset circuit 30, that trigger signal will trigger the reset pin of the MCU 20 to enable the MCU 20 to restart and initiate the reset operations for both the hardware and software components therein, such that interferences and errors accumulated in the settings of the MCU 20 can be cleared immediately.

Besides the abovementioned method, in this preferred embodiment the RC circuit 60 connects to the DC power circuit of the electronic device 1. When the plug 70 of the device 1 is removed from the power outlet, a trigger signal will be sent through the AND gate 40, forcing the reset circuit 30 to initiate a command to trigger the reset pin of the MCU 20 for commencing a reset operation.

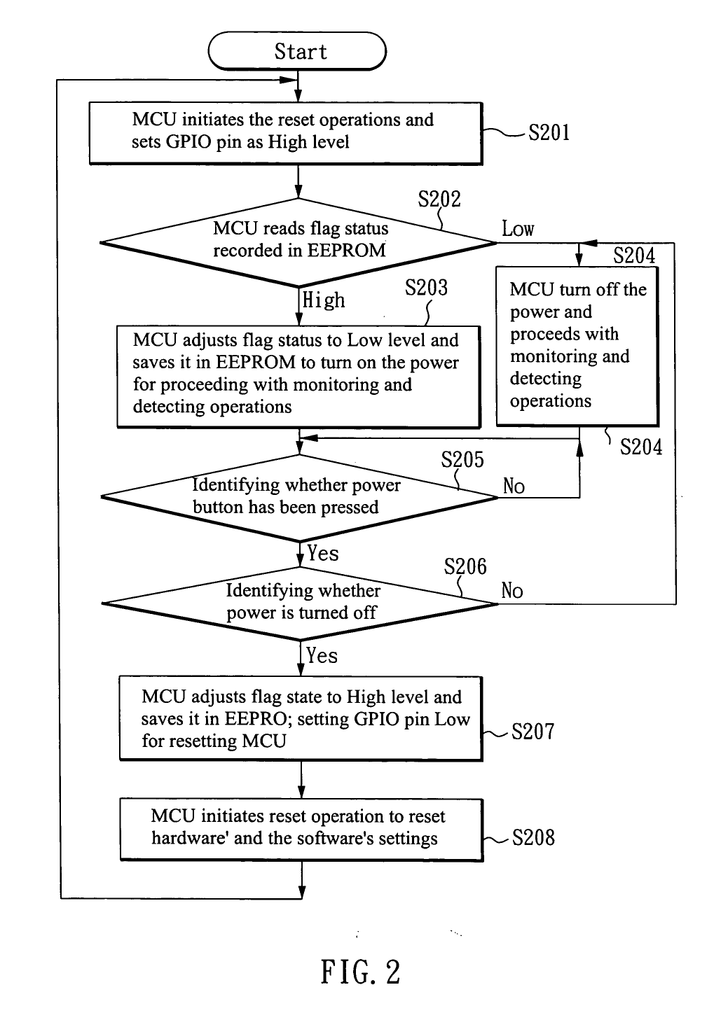

FIG. 2 further illustrates the steps in the method of the present invention for automatically resetting an MCU upon turning on the power. With reference of the circuit shown in FIG. 1 supplementary to FIG. 2, as the plug 70 of the electronic device 1 is plugged into the power outlet, the MCU received within the device will proceed with the reset operation and enter a standby mode. The method for automatically resetting the MCU upon turning on the power comprises the following steps: First, the MCU 20 undergoes the reset operations and sets the GPIO pin as High (step S201), followed by which the MCU 20 reads the flag 101 state regarding the current power status saved in the EEPROM 10 and identifies the current status of the flag 101 (step 202). If the flag status is set as High, the MCU will adjust the flag status to Low and save it in the EEPROM 10 to turn on the power for proceeding with the monitoring and detecting operations (step S203); if the flag status is set as Low, the MCU 20 will turn off the power and proceed with the monitoring and detecting operations (step S204). The power button 100 will be then be identified whether it has been pressed (step S205); if not pressed, the MCU should keep on identifying while waiting (step S205); on the contrary, if it has been pressed, then the MCU will identify whether the power is off at the time being (step S206). If current power is turned on, the MCU 20 will turn off the power to proceed with the monitoring and detecting operations (step S204); conversely, if the current power has been turned off, the MCU 20 will adjust the flag status regarding the power status to High and save it in the EEPROM 10 (step S207); meanwhile a GPIO pin is set as Low for resetting the MCU 20 (step S207). After a period of time (several milliseconds depending on each MCU 20), the MCU 20 initiates the reset operation to reset the settings of both the hardware and the software therein (step S208), followed by having the power turned on and continuing to proceed with the monitoring and detecting operations (step S201).

As described above, the circuit and the method of the present invention for automatically resetting the MCU upon turning on the power is to first automatically reset the MCU every time the electronic device is turned on (by pressing the power button), such that the internal hardware and software components of the MCU can restore their default values. Having done so, all the miscalculations and/or errors due to external interferences accumulated in the MCU can be immediately cleared, so as to improve the overall stability of the electronic products and avoid possible erroneous commands.

Although the present invention has been explained in relation to its preferred embodiment, it is to be understood that many other possible modifications and variations can be made without departing from the scope of the invention as hereinafter claimed.

What is claimed is:

1. A reset circuit for automatically resetting a microcontroller unit upon turning on a power, applied on an electronic device, comprising:
a power button;
an Electrically Erasable Programmable Read Only Memory (EEPROM), using a flag to record whether the power status of said electronic device is on or off;
a microcontroller unit, connecting with said EEPROM, wherein said microcontroller unit comprises a reset pin and a GPIO pin;
an AND gate having two input terminals, one of said input terminals connecting with a resistor capacitor circuit, the other input terminal connecting with the GPIO pin of said microcontroller unit; and
a reset circuit, connecting to the reset pin of said microcontroller and the terminal of said AND gate;
wherein, said microcontroller unit reads the flag state recorded in said EEPROM as said electronic device is plugged in an outlet of the power and said electronic device is under a standby mode; when the flag state is High, the GPIO pin of said microcontroller unit outputs a trigger signal through said AND gate and said reset circuit to trigger the reset pin of said microcontroller unit, enabling said microcontroller unit to reset settings of both the hardware and software therein.

2. The reset circuit as claimed in claim 1, wherein said electronic device is selected from the following group, including a television set, a video recorder and a DVD player.

3. The reset circuit as claimed in claim 1, wherein said power button is the power switch of said electronic device, on which said power button is mounted.

4. The reset circuit as claimed in claim 1 further comprising a resistor capacitor circuit, for connecting to a DC power circuit of said electronic device.

5. The reset circuit as claimed in claim 1, wherein the reset pin of said microcontroller unit is triggered, enabling said microcontroller to reset, as a plug of said electronic device is disconnected from the power.

6. The reset circuit as claimed in claim 1, wherein said flag state set as High implies said electronic device is turned on; and said flag state set as Low implies said electronic device is turned off.

7. The reset circuit as claimed in claim 1 further comprising a buffer that connects to the GPIO pin of said microcontroller unit and said AND gate.

8. A method for automatically resetting a microcontroller unit upon turning on a power, with which an electronic device is turned on, its microcontroller unit is automatically reset, and the power is controlled as the electronic device is plugged into an outlet for the power while being under a standby mode; said method comprises the followings steps:
(A) setting up an initial setting for said microcontroller unit and setting a GPIO as high level;
(B) reading the power flag status of an EEPROM by said microcontroller unit; executing step (C) if said flag status is at high level, executing step (D) if said flag status is at low level;
(C) adjusting the flag status to low level by said microcontroller unit and saving it in said EEPROM, turning the power on: proceeding with the monitoring and the detecting operations;
(D) turning the power off by said microcontroller unit: proceeding with the monitoring and the detecting operations;
(E) identifying by said microcontroller unit whether said power button has been pressed; if not pressed, continuing to identify; if said power button has been pressed, then executing step (F);
(F) identifying by said microcontroller unit whether the power is turned off at the time being; if so turned off, executing step (G), otherwise executing step (D);
(G) adjusting the power flag status to High by said microcontroller unit and saving it in said EEPROM; setting a GPIO as Low to reset said microcontroller unit; and
(H) initiating the reset operation by said microcontroller unit, resetting both the hardware and software settings therein, then again returning to step (A) for proceeding with further monitoring operation.

9. The method as claimed in claim 8, wherein said electronic device is selected from the following group, including a television set, a video recorder and a DVD player.

10. The method as claimed in claim 8, wherein said flag state set as High implies said electronic device is turned on; and, in said flag state set as Low, said electronic device is turned off.
